(19) United States
(12) Patent Application Publication
(10) Pub. No.: US 2024/0347916 A1
(43) Pub. Date: Oct. 17, 2024

(54) ELECTROMAGNETIC DEVICES AND METHODS FOR COMPLIANT ADJUSTMENT OF ELECTROMAGNETIC DEVICES

(71) Applicant: The Penn State Research Foundation, University Park, PA (US)

(72) Inventors: Galestan Mackertich-Sengerdy, State College, PA (US); Douglas Werner, State College, PA (US)

(21) Appl. No.: 18/626,367

(22) Filed: Apr. 4, 2024

Related U.S. Application Data
(60) Provisional application No. 63/495,608, filed on Apr. 12, 2023.

(51) Int. Cl. H01Q 9/04; H01Q 23/00

(52) U.S. Cl. CPC H01Q 9/0442; H01Q 23/00

(57) ABSTRACT

An electromagnetic device can include a compliant mechanism that can be actuated to move an element or multiple elements of the electromagnetic device between different positions, in-turn altering an electromagnetic or electric property of the device. At least one actuator can be utilized for adjustment of the body into the different positions. Examples of an actuator can include a servomotor, piston, or other type of linear motion actuator. Other types of actuators can include a motor connected to at least one gear or other type of rotatable mechanism that can be connectable to the compliant mechanism to drive movement of the compliant mechanism. Also, processes for adjusting a configuration of the electromagnetic device to adjust functionality of the device can utilize at least one compliant mechanism. Some embodiments can facilitate robust reconfiguration of an electromagnetic device with the ability to design the constituent components to not disrupt electromagnetics.

### CROSS-REFERENCE TO RELATED APPLICATIONS

The present application claims priority to U.S. Provisional Patent Application No. 63/495,608, which was filed on Apr. 12, 2023. The entirety of U.S. Provisional Patent Application No. 63/495,608 is incorporated by reference herein.

### FIELD OF INVENTION

The present invention relates to antennas and other electromagnetic devices and methods of making and using the same. Embodiments can be configured to utilize a compliant adjustment mechanism to facilitate a structural adjustment to an electromagnetic device to adjust reception, or transmission capabilities of the device to better account for a particular environment of the device. Embodiments can be structured as antennas, reconfigurable antennas that interact with electromagnetic fields, reconfigurable antennas that the deployment structure does not interact with the electromagnetic fields, high-power antennas, high-power metamaterials, band gap filters, reconfigurable band stops, electromagnetic phase shifters, electromagnetic filters, reflectarray antennas, resonators, high-power capable electromagnetic devices, and other types of electromagnetic devices.

### BACKGROUND OF THE INVENTION

Reconfigurable antennas are often provided for achieving reconfigurability in the radio frequency (RF), microwave, and millimeter-wave frequency regimes. Current reconfigurable antenna solutions can be classified according to their method of achieving actuation. A sub-class of reconfigurable antennas are antennas that dynamically achieve an adaptable transformation of their frequency, radiation-pattern, polarization, and/or bandwidth characteristics to enable multiple dynamic functionalities. One of the first reconfigurable antenna systems was published in 1935 and was designed so that the radiation pattern of a rhombic antenna could be modified by adjusting counterweights to vary wire element angle to change the resultant radiation pattern.

One of the most popular types of mechanically reconfigurable antennas are those referred to as Origami Antennas (OA) as they take their inspiration from the Japanese art of paper folding. Typically, for OAs, specific behaviors and material performance assumptions need to be made in order to realize targeted functionality. Some of these limitations include requiring a sufficiently thin target substrate with negligible elasticity and that the folding sections of the OAs can include motion that is not along substrate folds. Moreover, if the substrate thickness is increased to improve mechanical rigidity, then the problem of self-avoidance or non-self-intersection starts to play an ever-increasing role. Other limitations of OAs include structures and patterns that are not typically rigid/robust for field deployability and are limited in their stacking and implementation into three-dimensional structures. Also, configurations for OAs often incur substantial cost due to the material properties and structural requirements that can exist for such systems.

### SUMMARY OF THE INVENTION

We have recognized that traditional mechanically reconfigured systems as well as origami-based solutions, and other thin-substrate based methods have numerous draw backs that can limit their deployability and suitability for use in various applications. We determined that a new type of electromagnetic device is needed that can help overcome such shortcomings and provide adjustable deployment options to allow a device to be structurally adjusted to permit the device to work better and more reliably in a particular environment it may be situated in that can also be less costly to design and manufacture and use. Embodiments of our electromagnetic device can utilize one or more compliant mechanisms that can be adapted to permit a compliant material's inherent elastic properties to create a desired motion through a controlled deformation into different orientations via one or more actuation mechanisms. This type of approach can contrast with multiple rigid bodies, thin substrates, folding, pins, bearings, and bushings used to develop motion in traditional rigid body kinematic systems, including those used in origami-based systems, while also providing significant improvements in durability, manufacturing options, and performance.

For example, embodiments of an electromagnetic device can include a body having a compliant mechanism. The body can be continuously adjustable between different orientations via the compliant mechanism for adjusting at least one electromagnetic property of the device.

In some embodiments, the device can include a plurality of arms attached to pins (e.g. short pins). The arms can be resiliently moveable via rotation of a portion of the body. The pins can be in contact with a ground plane below the arms and also be in contact with an upper radiating patch above the arms during motion of the arms. The arms can be movable via rotation of the portion of the body to adjust positions of the short pins around a feed pin.

In some embodiments, the body can define a unit cell that is compressible from a relaxed state to multiple different compressed states via the compliant mechanism. For example, in some configurations the body can be compressible via application of at least one linearly applied force.

In some embodiments, the compliant mechanism can include a first pre-defined axis of flexion and a second pre-defined axis of flexion that is transverse or perpendicular to the first pre-defined axis of flexion. A transverse orientation can be an orientation that is within 10° or within 20° of the second pre-defined axis of flexion being perpendicular to the first pre-defined axis of flexion in some embodiments. In other embodiments, the transverse second pre-defined axis of flexion can be at an angle such that the second pre-defined axis crosses the first pre-defined axis.

The electromagnetic device can also include other elements. For example, the electromagnetic device can include at least one actuator positioned to engage the body to adjust the orientation of the body. A controller can be communicatively connected to the at least one actuator. In some embodiments, the actuator(s) can be or include at least one servomotor, at least one piston, or at least one other type of linear motion actuator.

The electromagnetic device can be configured as different types of devices. In some embodiments, the electromagnetic device can be configured as an antenna, for example.

Embodiments of the electromagnetic device can be adjustable between at least one orientation at which the device is a band stop filter and at least one orientation in which the device is a band pass filter. Such an orientation adjustment can be provided via the compliant mechanism (e.g. compression of the compliant mechanism and extension of the compliant mechanism can adjust the device into different orientations).

A process for adjusting at least one electromagnetic parameter of a device is also provided. Embodiments of the process can utilize an embodiment of the electromagnetic device, for example. Embodiments of the process can include adjusting an orientation of a body of an electromagnetic device by engaging the body via at least one linearly applied force and/or at least one rotationally applied force.

Embodiments of the process can also include other steps or features. For example, the process can also include determining that the at least one electromagnetic parameter fails to meet a pre-selected criteria. The adjusting of the orientation of the body can be performed in response to the determining that the at least one electromagnetic parameter fails to meet a pre-selected criteria.

In some embodiments, the compliant mechanism can be defined in the body to facilitate continuous adjustment in the orientation of the body between a first orientation and a second orientation.

In some embodiments, the process can be configured so that the adjusting of the orientation includes one or more of moving arms of the body, rotating arms of the body, flexing the body about a first pre-defined axis of flexion and flexing the body about a second pre-defined axis of flexion. The first pre-defined axis of flexion can be perpendicular to the second pre-defined axis of flexion in some embodiments.

In some embodiments, the adjusting of the orientation can change the at least one electromagnetic parameter such that the device is adjustable from a band stop configuration to a band pass configuration. For example, in some embodiments, the adjusting of the orientation can change the at least one electromagnetic parameter such that the device is receptive within a band that is over 2 GHz. In some embodiments, the band that is over 2 GHz can be a band that is between 3.46 GHz and 6.37 GHz or the band can be between 3.5 GHz and 6.2 GHz.

Systems and apparatuses that may be configured to utilize an embodiment of the process and/or at least one embodiment of the electromagnetic device can also be provided. Embodiments of such a system or apparatus can include other features or mechanisms. For example, computer devices, controllers, actuators, or other mechanisms can be utilized in such a system or apparatus.

Other details, objects, and advantages of the invention will become apparent as the following description of certain present preferred embodiments thereof and certain present preferred methods of practicing the same proceeds.

### BRIEF DESCRIPTION OF THE DRAWINGS

Exemplary embodiments of our electromagnetic device, systems and devices that utilize one or more embodiments of our electromagnetic device, processes for adjusting a structure of an electromagnetic device, and methods of making and using the same are shown in the accompanying drawings. It should be appreciated that like reference numbers used in the drawings may identify like components.

FIG. 1 is a flow chart illustrating a first exemplary embodiment of an electromagnetic device being moveable between multiple different positions via compliant motion of a compliant mechanism of the device along with a schematic illustration of how an electromagnetic field is adjustable via that motion.

FIG. 2 is a perspective view of the second exemplary embodiment of an electromagnetic device.

FIG. 3 is a perspective view of the second exemplary embodiment of the electromagnetic device.

FIG. 4 is a flow diagram illustrating different configurations of a third exemplary embodiment of the electromagnetic device providable via the compliant mechanism of the device.

FIG. 5 is a perspective view of a fourth exemplary embodiment of the electromagnetic device with a portion of the device cut away to illustrate internal components.

FIG. 6 is a perspective view of an exemplary compliant mechanism of the fourth exemplary embodiment of the electromagnetic device.

FIG. 7 is an exploded view of the fourth exemplary embodiment of the electromagnetic device.

FIG. 8 is a schematic view of the exemplary compliant mechanism of the fourth exemplary embodiment of the electromagnetic device.

FIG. 9 is a schematic view of the exemplary compliant mechanism of the fourth exemplary embodiment of the electromagnetic device in a first configuration.

FIG. 10 is a schematic view of the exemplary compliant mechanism of the fourth exemplary embodiment of the electromagnetic device in a second configuration.

FIG. 11 is a graph illustrating frequency adjustments that can be provided via adjusting a configuration of the exemplary compliant mechanism of the fourth exemplary embodiment of the electromagnetic device.

FIG. 12 is a graph illustrating ideal calculated patch radius corresponding to a given frequency with the traditional dielectric loaded circular cavity model (“cavity model simulated” data points) compared against the measured resonant peaks extracted from the S11 data (“From CMA Measured” data points).

FIG. 13 is a series of graphs illustrating four shorting pin states (states 0, 8, 16, and 24) for a prototype of the fourth exemplary embodiment of the electromagnetic device and the comparison of measured S11 magnitudes versus simulated results.

FIG. 14 is a graph illustrating measured gain results from evaluation of a prototype of the fourth exemplary embodiment of the electromagnetic device as compared to a traditional quarter-wavelength monopole antenna.

FIG. 15 is an illustration of simulated radiation patterns for different frequencies comparing the different patterns between the prototype of the fourth exemplary embodiment of the electromagnetic device as compared to a traditional quarter-wavelength monopole antenna.

FIG. 16 is a series of graphs illustrating simulated and measured results from simulated and measured co-polarization results for the prototype of the fourth exemplary embodiment of the electromagnetic device (φ=0).

FIG. 17 is a perspective view of the prototype of the fourth exemplary embodiment of the electromagnetic device evaluated in the graphs of FIGS. 14, 15, and 16.

FIG. 18 is a perspective view of the traditional quarter-wavelength monopole antenna evaluated in FIGS. 14 and 15.

FIG. 19 is a series of graphs illustrating measured antenna co- and cross-polarization performance for an exemplary embodiment of the electromagnetic device.

FIG. 20 is a flow diagram illustrating different configurations of a fifth exemplary embodiment of the electromagnetic device providable via the compliant mechanism of the device.

FIG. 21 is a flow diagram illustrating different configurations of a sixth exemplary embodiment of the electromagnetic device providable via the compliant mechanism of the device.

FIG. 22 is an exploded view of a seventh exemplary embodiment of the electromagnetic device.

FIG. 23 is a perspective view of the seventh exemplary embodiment of the electromagnetic device also illustrating an enlarged view of a compliant mechanism of that embodiment.

FIG. 24 is a perspective view of an eighth exemplary embodiment of the electromagnetic device also illustrating an enlarged view of a compliant mechanism of that embodiment.

FIG. 25 is a sequence of exemplary orientation positioning that can be provided by a compliant mechanism 3 of the seventh exemplary embodiment of the electromagnetic device adjacent to radiation pattern results indicating how such orientation adjustment can provide pattern fidelity and realized gain performance. The illustrated first orientation in FIG. 25 is a broadside configuration and the second orientation shown in FIG. 25 is a steered orientation.

FIG. 26 is a block diagram of an exemplary embodiment of an apparatus that can utilize at least one exemplary embodiment of our electromagnetic device 1.

### DETAILED DESCRIPTION

Embodiments of our electromagnetic device can be appreciated from FIGS. 1-26. Some embodiments can include a device configured as a reconfigurable tailored compliant-mechanism antenna based on a simple circular shorted patch. The compliant mechanism structure for that exemplary embodiment can be additively manufactured (3D printed) iris-type model which can be designed to achieve a continuous frequency reconfiguration across a band (e.g. a band of 3.5 GHz to 6.2 GHz at a radiation efficiency greater than 80% as discussed below for an exemplary embodiment, other pre-selected frequency band, etc.). As discussed herein, embodiments can be configured for utilization of various types of manufacturing methods, be configured as a different type of electromagnetic device instead of an antenna (e.g. a band gap or band stop, a filter, a phase shifter, a resonator, etc.), and/or have other properties. Different embodiments can be designed and configured for operation to achieve a relatively large operational bandwidth at different frequency bands (e.g. an operational bandwidth of 1.5 GHz to over 2 GHz for a pre-selected frequency bandwidth value (e.g. 3 GHz to 5.5 GHz, 1 GHz to 3.4 GHz, etc.).

Other embodiments of our electromagnetic device 1 can include a compliant mechanism 3 as well as discussed herein. The complaint mechanism of an electromagnetic device 1 can be configured to permit a body 2 of the device to be adjusted into different shapes or configurations to adjust how that device 1 can interact with an electromagnetic field 7 or generate such a field 7 to provide improved performance (e.g. improved reception and/or transmission of signals, etc.). One or more actuators 4 can be utilized to move the body 2 of the electromagnetic device 1 via its compliant mechanism for adjustment between different configurations of the body (e.g. different shapes or orientations, adjustment between a first orientation, a second orientation, a third orientation, and/or other orientations, etc.).

Embodiments of the compliant mechanism 3 can be configured so that the body 2 of the device 1 is adjustable between different orientations, or configurations, so that the shape of the device is altered by use of one or more actuators to drive the adjustment of the configuration of the device. An actuator can be (or include), for example, a servo, a servomotor, a piston, a pulley, or other type of actuator. A controller can be provided to control the actuator(s) to cause adjustment of the electromagnetic device between its different configurations. The type of adjustment that is made can be based on one or more parameters fed to the controller. The parameters can include one or more sets of data obtained by one or more sensors connected to the electromagnetic device or via the controller's connection to the electromagnetic device. Examples of parameters can include, for example, uplink/downlink requirements, polarization change requirements, frequency change requirements, frequency drift due to temperature, radiation pattern change requirements, such as steering or tracking, etc. Such parameters can each be evaluated based on use of one or more pre-selected parameter thresholds to trigger actuation of an adjustment.

The controller can respond to the received parameter data by evaluating that data and providing communications to one or more actuators for actuation of the actuator to cause an orientation change in the body 2 via a compliant mechanism 3 for adjustment in the configuration of the electromagnetic device based on the evaluated parameter data. The orientation change can be effected via rotational force and/or linear force applied to the body 2, for example.

The controller can be part of a computer device or can be included in an apparatus to facilitate communications involving at least one computer device.

Actuators 4 can be provided in various ways. For example, one or more actuators 4 can be provided with an associated control system that can use at least one controller. The control system having at least one actuator 4 can be positioned external to a device 1 or be positioned below a ground plane GP of a device 1 and be provided to avoid interfering with the electromagnetic operation of the device 1. Actuators can include, for example, one or more manually operated levers, automatically controlled levers, at least one gear or pulley mechanism that can be manually or automatically controlled via a controller, a linkage-based system located away from the critical internal components of the device that can be manually or automatically controlled via a controller, at least one servo, or other type of actuator.

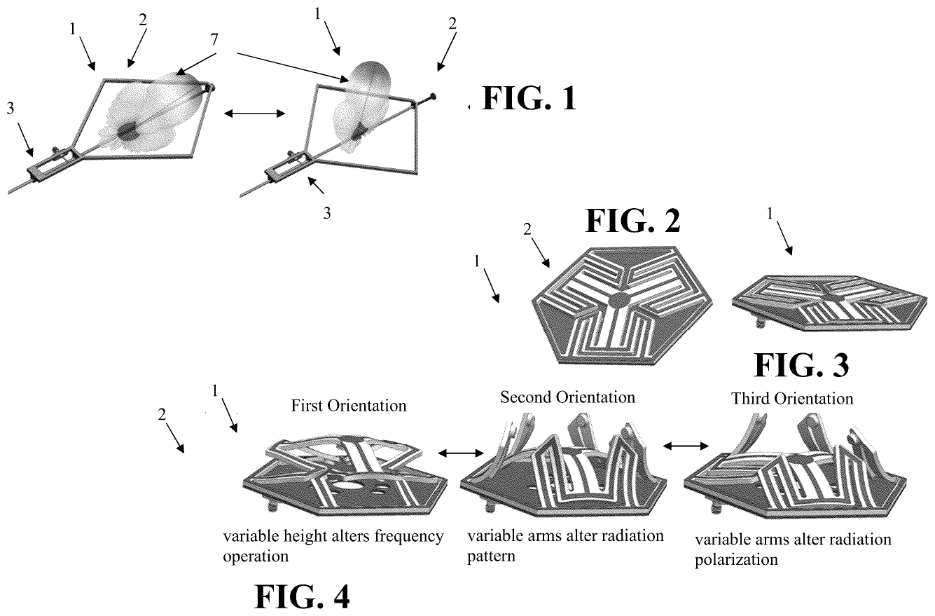

FIGS. 1-4 illustrate different exemplary embodiments of our electromagnetic device 1. The body 2 of the device 1 can be relatively simple in shape and include a compliant mechanism 3 that relies on resiliency of the body for mechanical deformation of a beam structure of the body 2 to adjust an orientation of the body via continuous motion of the body between different orientations that can change the shape and/or geometry of the body 2. This type of body adjustment can be achieved by the continual application of a force to a portion of the body (e.g. a front section of the device, one or more sides of a device, etc.). The application of force via one or more actuators 4 can cause a controlled distortion to the total structure of the body 2 via the compliant mechanism 3 of the body 2. These types of devices can be provided via the compliant mechanism 3 in either a continuously variable state or discrete selection state. For example, instead of the relatively simple continuous adjustment body 2 of the embodiment shown in FIG. 1, an embodiment can include a more complex shaped body 2 (examples of which is shown in FIGS. 2-4) that can utilize a lamina emergent translator for a continually reconfigurable electromagnetic device (e.g. FIG. 2) or a body that can permit height adjustment as well as arm motion to further adjust a shape of the body 2 (e.g. FIGS. 3-4). Along with the concept of multiple antenna radiation reconfiguration (e.g. as shown in FIG. 4), frequency tuning, filtering, or other electromagnetic parameters can be incorporated into the shape of the body 2 and adjustment between different orientations of the body 2. Due to the wide variety of choices between discrete or continuous deformation profiles available, the structure of the body 2 for the device 1 can be provided for altering dimensions or overall shape based on a desired application that is to be achieved (e.g. a particular band range for an antenna, a particular filtering criteria, etc.).

The body 2 of the device 1 can be provided and defined for reconfigurable frequency selective surfaces, phase gradient surfaces or electromagnetic metasurfaces. A compliant mechanism 3 of the body 2 of the device 1 can be provided so the device 1 can be integrated into antenna accessories such as ruggedized radome structures that can provide beamforming capabilities to current static antenna setups as well as other uses for other types of electromagnetic devices.

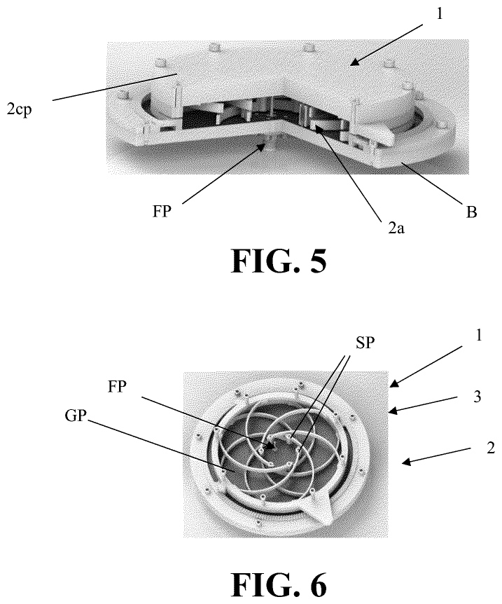

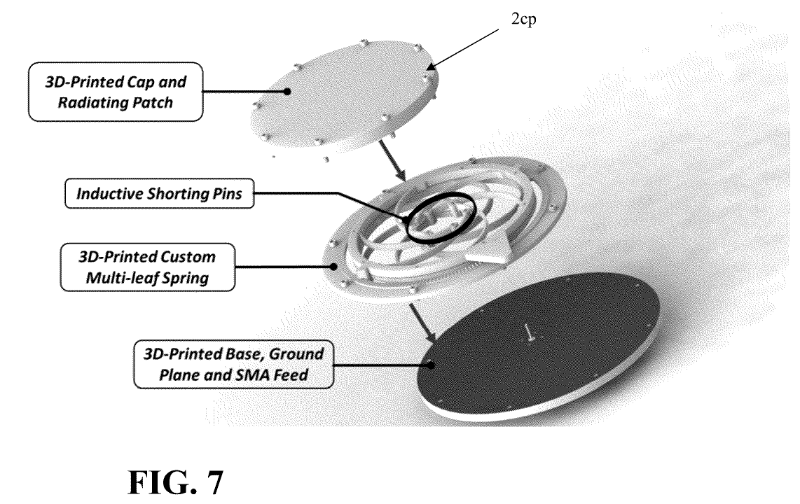

FIGS. 5-10 illustrate an exemplary embodiment of our electromagnetic device 1 that can be configured as a type of patch antenna. FIGS. 5-7 illustrates shorting pins of the device 1. The body 2 also includes overlapping iris arms 2a attached to the shorting pins SP that are movable via deformation of the arms to allow motion of the shorting pins SP and adjustable positioning of the pins via the changed orientation of the arms 2a. The electromagnetic device 1 also includes a feed pin FP that is in contact with a top radiating patch 2cp. FIG. 6 illustrates the device 1 with its top plate removed for showing the orientation of the shorting pins in the smallest diameter configuration (e.g. a first orientation or other orientation of the body 2). FIG. 7 is an exploded view of the device 1 where some of the main components of the device 1 are visible—(i) a cap and radiating patch 2cp, (ii) the compliant mechanism 3 and shorting pins SP, and (iii) the base B with the ground plane GP and feed pin FP (e.g. an antenna feed).

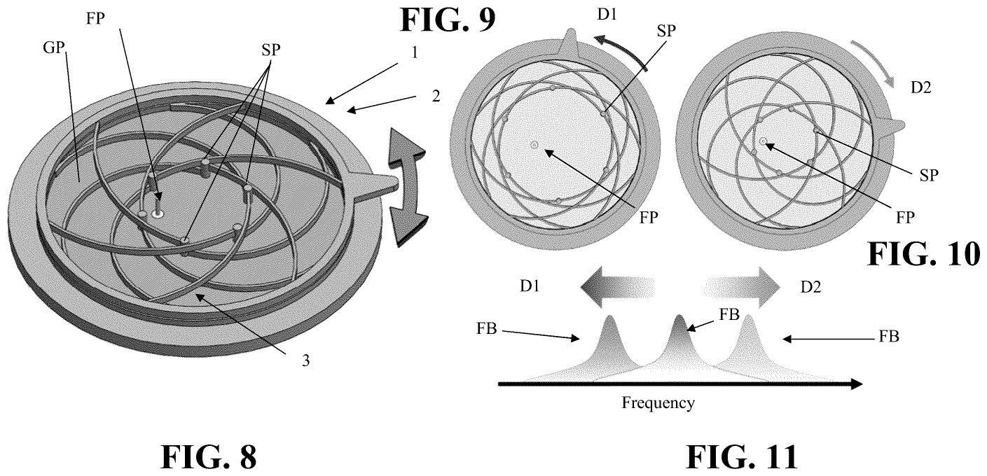

FIGS. 8-10 may best illustrate operation of the device 1 that can be provided via a compliant mechanism 3 to adjust antenna characteristics of the device via adjustment of the body 2 between different orientations that can be provided as a result of resilient, compliant, motion of the iris arms 2a. An actuator can provide a rotational force to the body for rotating a portion of the body to cause the arms 2a to be displaced for changing the location of the shorting pins SP attached to distal ends of the arms 2a. The arms 2a can be provided as leaf springs or leaf spring elements for example so that the arms 2a can be symmetrically moved via resilient motion of the arms 2a due to rotation of the rotational part of the body 2 to which the arms are connected. The body 2 can be configured so that the body has a rotational component connected to the arms to drive motion of the arms 2a. The rotational component can be rotational in a first direction D1 and a second direction D2 that is opposite the first direction D1 (e.g. the first direction can be clockwise and the second direction can be counterclockwise or the first direction can be counterclockwise and the second direction can be clockwise). The arms 2a can be moved around a center of the body 2 to be adjustably positioned around the feed pin FP via rotation of the rotational component of the body 2, for example. The shorting pins SP can be attached to the arms 2a to travel with the arms as the arms move so that the shorting pins SP remain in contact with the ground plane GP as they are moved along the bottom ground plane GP and are also in contact with the upper patch element 2cp as they are moved along the upper radiating patch element 2cp of the device 1 during motion of the arms 2a and shorting pins SP. This type of compliant mechanism can provide a continuously variable resonant frequency reconfiguration to be achieved by the antenna through a mechanical action (e.g. rotation via the rotational component attached to the arms 2a).

The shape and motion of the arms 2a that adjust the locations of the shorting pins SP relative to the feed pin FP can change the resonant frequency of the device to create an operational frequency band FB for that configuration or orientation. Because the device can be adjustable into different orientations via continuous motion, it can have continuously varying frequency reconfiguration. This motion is repeatable and due to the fixed rotation limit as well as the elastic properties of the material of the body 2, the displaced arms 2a can rebound back to their original state while also providing a high cycle lifetime.

The motion of the arms 2a and the shorting pins SP provided via rotation can be driven by one or more actuators 4 (not shown). At least one actuator can include, for example, a manually operated level or gear assembly or an automatically controllable gear assembly, pulley assembly, or linkage assembly. The actuator can be provided below the ground plane GP to avoid interfering with electromagnetic operation of the device 1.

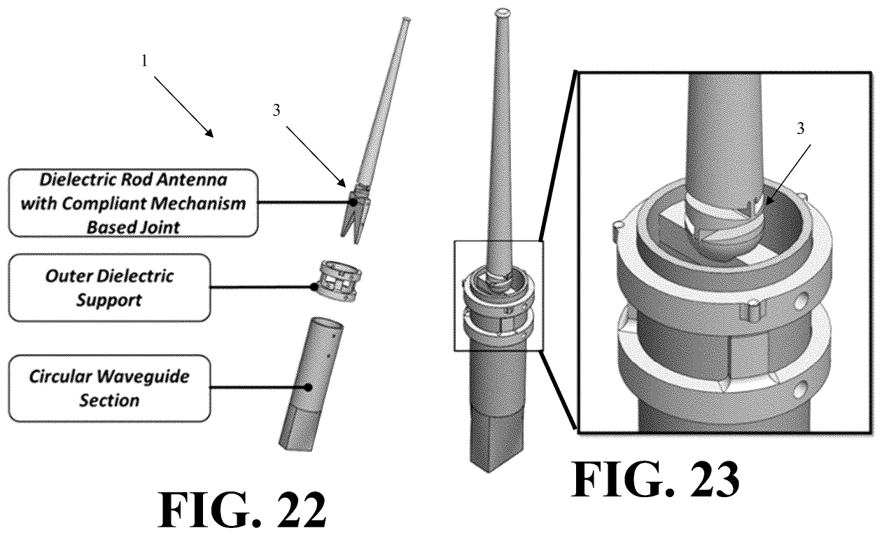

The compliant mechanism 3 can be defined in a body of the device 1 to provide at least one type of controlled deformation for adjustment of the device between multiple orientations. For example, the compliant mechanism 3 can be leaf spring elements defined in a body (e.g. as arms or as members of a body) that can be moved or deformed via application of a force (e.g. pressing or pulling on at least one side of a body, rotating a rotational element of a body to which the arms are attached or engaged for compressing or deforming the arms to move the arms, etc.). In some configurations (e.g. embodiments shown in FIGS. 22-25), the compliant mechanism can include multiple defined living hinges that can be arranged perpendicular or transverse to each other to define axes of flexion and also be vertically spaced apart from each other so that deformation of the body into different orientations can be defined to occur via flexion about those pre-defined axes. Yet other embodiments can be configured to utilize a combination of such compliantly defined body portions to provide a compliant mechanism 3.

Adjustment between orientations of the device can be provided via the compliant mechanism 3 so continuous adjustment between a first orientation and a second orientation can permit numerous other orientations to be defined between the first and second orientations of the device 1. This type of adjustment can be provided via application of at least one force that can be provided by at least one actuator 4. The actuator(s) 4 can be controlled via manual force or via automatic control provided by a controller connected to the actuator(s). The controller can provide automatic control or can be responsive to user input provided to the controller (e.g. via use of at least one input device to provide at least one control input to the controller) for automatically controlling the actuator(s) 4. The controller connected to the actuator(s) 4 can have a processor that is connected to non-transitory memory and one or more sensors. The memory can include code that defines instructions that the controller is to follow for defining a method by which the controller may control the actuators based on data the controller receives from one or more sensors.

In some configurations, the controller can also (or alternatively) be communicatively connectable to a user device (e.g. computer system, computer device of an operator, etc.) and can respond to input data communicated to it via the user device for adjustment of the position of the actuator(s) 4 for adjusting the orientation of a device. In such embodiments, the user device can be communicatively connectable via a network connection that may involve use of one or more intermediate nodes for the communication connection (e.g. access point(s), gateway(s), etc.).

### First Example—Evaluation of an Exemplary Embodiment

An embodiment of our device 1 having a design shown in FIGS. 5-9 and 17 was fabricated to form a prototype for use in evaluation of the embodiment and comparison of performance of that embodiment with a conventional circular microstrip patch antenna that is shown in FIG. 18. The prototype that was fabricated was designed so that it could provide stable operation from 3.46 GHz to 6.37 GHz, which provides nearly an octave of continuously variable frequency reconfiguration and demonstrated the ability of the compliant mechanism 3 of the device 1 to provide a substantial improvement in performance compared to conventional devices.

For the conducted evaluations discussed below, a conventional circular microstrip patch antennas can be represented as a dielectric loaded circular cavity model. This technique can allow for the derivation of the resultant electric and magnetic fields inside the cavity as well as provides analytical expressions for predicting the far-field radiation patterns. The cavity model can also yield an expression to predict the approximate resonant frequency corresponding to a particular circular patch radius, substrate thickness and dielectric constant.

Additionally, microstrip patch antennas operating in higher-order modes can generate patterns with nulls in the broadside direction similar to a classical monopole antenna radiation pattern. To excite these higher order modes, multiple shorting pins arranged symmetrically at a specific radius around a center-fed circular patch antenna can create the traditional monopole antenna type radiation pattern. Using the dielectric loaded cavity model and higher order operational modes, the approximate resonant frequency of the system in relation to the circular patch size can be readily determined.

When comparing to all-electronic means of frequency reconfiguration, the common Field Effect Transistor (FET) switches, pin-diodes and varactors either obtain a binary option of frequency selection e.g., for Wi-Fi dual-band operation, or if implementing a simple control circuitry, the bandwidth of frequency operation is increased by less than 10%. Some implementations double the frequency range of operation but are binary solutions and alter the radiation pattern. A variable frequency antenna utilizing varactor components was able to achieve continuous frequency reconfiguration, but the operational frequency bands are limited by the bias-voltage thresholds of the varactors. This can be seen in the designs achieving a range of 6.16-6.47 GHz or dual-band antennas that operate at 1.68-1.93 GHz and 2.11-2.51 GHz for the low-band and high-band modes respectively.

The prototype of an embodiment of our device that was fabricated was designed to achieve a high-gain conical or monopole type radiation pattern for a frequency regime that exceeds current state-of-the-art all-electronic solutions, while also offering other performance advantages such as structural robustness and actuation simplicity. For the design presented in this particular embodiment, the overall radiation pattern was able to be modified by the inclusion of slots, parasitic elements, or even a second conductive layer with a metasurface to perform beam manipulation.

To design this particular prototype of one exemplary embodiment of our device, a number of device parameters were selected. These included selecting ground plane dimensions, feed method, and various top patch sizes for the antenna. The sizing and shaping of these elements were parametrically adjusted to achieve the desired operational frequency range. Next, the approximate total device height, including the top patch location and supporting structure for the radiating patch, were varied parametrically to determine their total impact on the system as well as to obtain required reconfigurable compliant mechanism design constraints. Then the largest patch geometry was modeled using commercial full-wave simulations tools and the shorting pins were designed based on readily available Commercial Off The Shelf (COTS) parts and existing manufacturing practices.

A parametric sweep of the number of shorting pins and their total body radius was performed to provide insight to the effects of shorting pin inductance in series with the static capacitance of the patch antenna model. A determination of the best shorting pin radii and their radial locations along with the antenna feed point were considered at this step to achieve the desired operational frequency range and optimal feed matching conditions for this particular embodiment based on a pre-selected set of design criteria.

An independent mechanical model of the chosen compliant mechanism, based on approximated material properties, was simulated to assess the shorting pin displacement profile. These displacement paths were then incorporated into the electromagnetics model as well as Radio Frequency (RF) material properties to increase its accuracy. Lastly, parametric sweeps of the entire structure were performed to select a design that would provide the most robust manufacturing tolerances while maintaining the desired electromagnetic performance.

During the design process, a suitable material for the prototype was chosen that accommodated desired RF properties (e.g. low-loss across the large range of frequencies), as well as pre-selected mechanical properties that were desired to achieve consistent operation without fracturing. 3D printable material Verowhite from Stratasys was chosen as a material for the body 2 for the prototype that was made due to its combination of acceptable RF properties and favorable mechanical properties for this particular prototype. The three separate components (exploded view shown in FIG. 7) were designed to create the entire antenna were additively manufactured, and copper plates were bonded to the surface to metalize the ground plane GP and radiating patch 2cp regions. The main source of loss to the device 1, which was configured as an antenna for this evaluation of this prototype, was from the rigid top support structure of the device 1. In simulations that were conducted, this loss was accounted for by including it in the parameter variables. The compliant structure inside the resonant cavity area of the device had minimal losses due to targeted reconfiguration design.

Custom shorting pins SP were fabricated for the prototype of our device 1 used in the comparison and evaluation work based on the optimal dimensions found from RF simulations. The inductance values that achieved the best matching for all the configuration scenarios were directly correlated to the internal and external radii of the pin shaft, as well as the commercial spring-pin dimensions. The shorting pins SP (six were used in this particular prototype) were fabricated by incorporating standard COTS spring contacts in custom turned copper rods and press-fitted together. After 3D printing, the entire structure was assembled using nylon 4-40 screws. As noted above, the prototype was designed so that the shorting pins SP traveled along the ground surface of the ground plane GP when the outer ring component was manually actuated for rotation to drive resilient motion of the arms 2a for adjusting the orientation of the device 1 and locations of the shorting pins SP around the feed pin FP.

The final weight of the fabricated device 1 that was used in the conducted testing was 270 grams. To put this value in perspective, a simple commercially available 2.4-2.5 GHz antenna with a radome is stated to weigh 40 grams and is 83 mm in diameter. Also, a commercially available wideband antenna (1.5 GHz through 4 GHz) often weighs over 0.4 kg.

The weight of the fabricated device for conducted evaluation work discussed above does not include a mass for any type of reconfiguration control system that can be provided for driving motion of the arms 2a to adjust orientations of the device 1. In the formed prototype, the orientation adjustment of the device was configured to for manual adjustment, so no type of automated control system or controller based control system was utilized in this particular prototype.

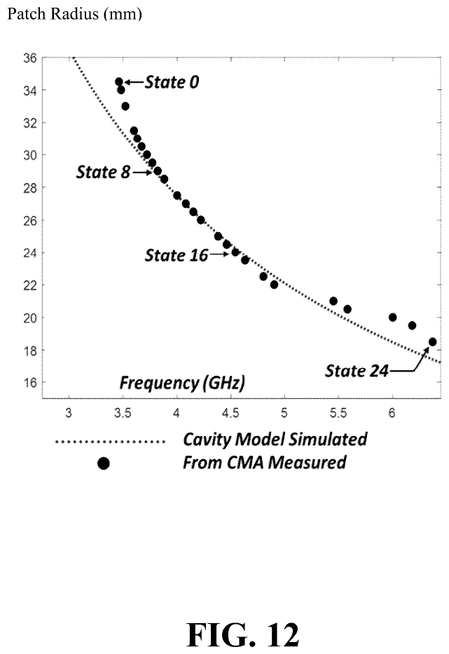

FIG. 12 is a graph that illustrates the ideal calculated patch radius corresponding to the given frequency with the traditional dielectric loaded circular cavity model (curve) compared against the measured resonant peaks extracted from the S11 data (larger black data points). The dielectric loaded circular cavity model is bounded by Perfectly Magnetic Conducting (PMC) walls, as well as two Perfect Electric Conducting (PEC) surfaces on the top and bottom.

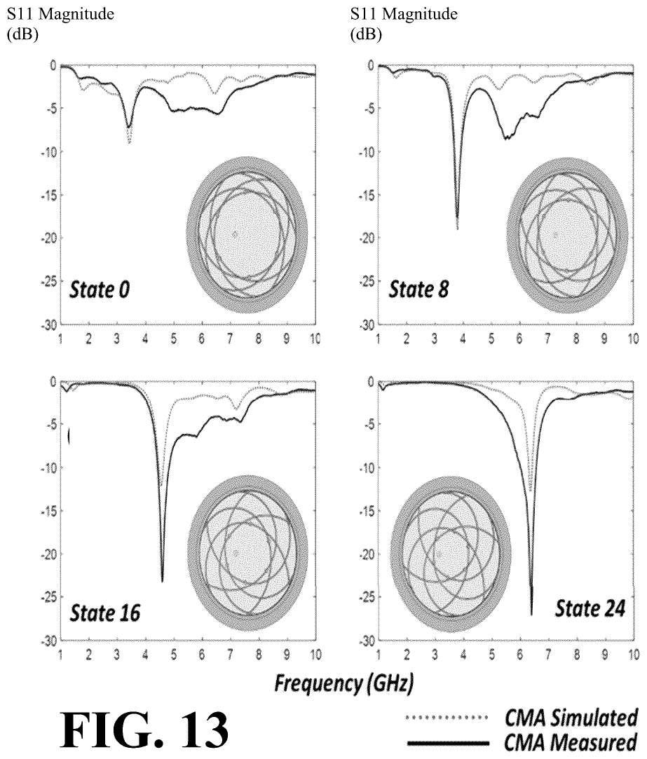

FIG. 13 illustrates four shorting pin states, which can also be considered device orientations. These states are labeled in FIG. 12 and the comparison of measured S11 magnitudes versus simulated results are shown in FIG. 13 for the different orientations. The cavity model was used to determine the dielectric loading as well as the maximal travel constraints of the shorting pins to achieve frequency reconfiguration. A full-wave FEM model was utilized to tune the shorting pin parameters, total heights and verify the estimated dielectric loading values.

The measured S₁₁ (i.e., return loss or reflection coefficient) for four chosen configuration states 0, 8, 16, and 24 shown in FIG. 13 and the comparison of the circular cavity model approximation of the circular patch size (smaller data points of the graph) to the measured resonant frequency magnitude minimums of the fabricated compliant mechanism antenna (larger data points of the graph) shown in FIG. 12 illustrate an evaluation of the formed prototype as compared to a conventional antenna. The Sn results as well as the radiating patch sizes produced by adjusting the shorting pin locations agree very well with the predicted results. It can be seen in some cases presented, that the resonant magnitudes are lower than in the simulated case, which is believed to be attributed to the losses within custom spring-pin manufacturing as well as losses due to a lower-than-expected pressure contact force of the shorting pins along the copper surfaces.

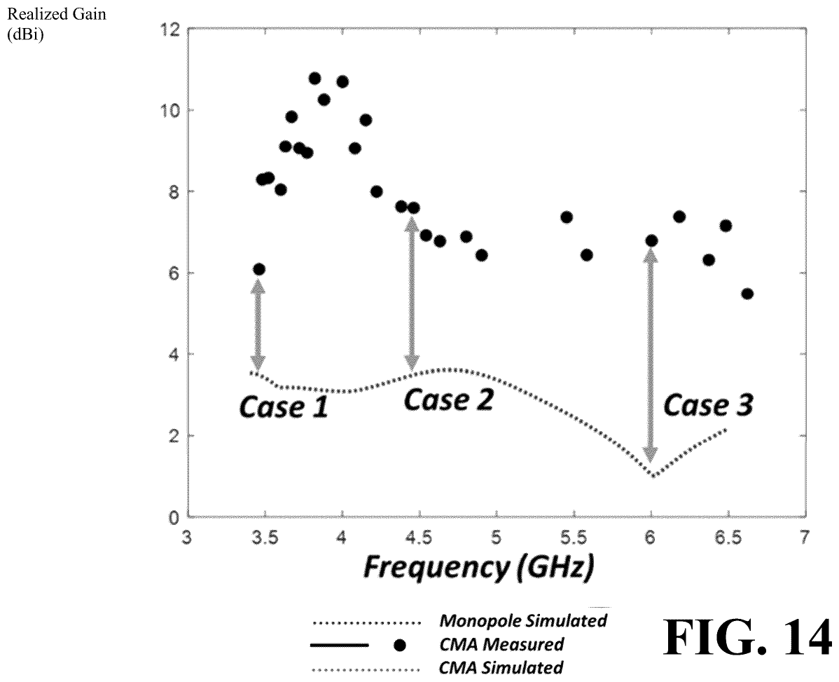

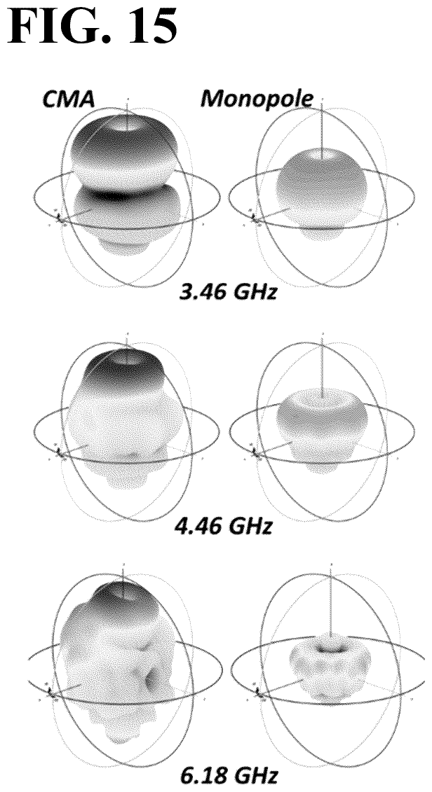

The formed prototype was included in a full antenna mounted to an anechoic chamber (ETS-Lindgreen) tower adapter plate. Each independent configuration state was selected by manually rotating and aligning to a desired angle. Friction between the shorting pins, ground plane, radiating plate and the guide channels of the device 1 held the selected rotation angle. The radiation pattern was then captured and stored for processing in conducted evaluations. The far-field patterns are shown in FIG. 15 and agree well with simulated predictions. Realized gain in the three cases presented are 6.1 dBi at 3.46 GHz, 7.6 dBi at 4.46 GHz, and 7.4 dBi at 6.18 GHz. Maximum realized gain of 10.8 dB was achieved at 3.82 GHz. Also, as demonstrated in FIG. 14 realized gain didn't drop below 6 dBi until 6.62 GHz.

Since the measurements agree well with the simulations, we can confidently conclude that the total antenna efficiency for the formed prototype was greater than 80% across the band of 3.5 GHz to 6.2 GHz.

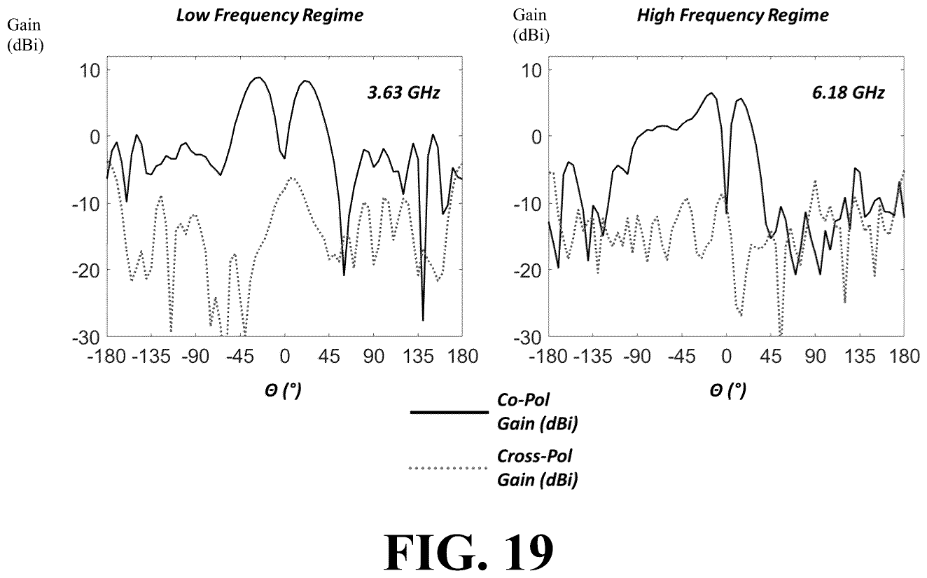

Cross-polarization for the prototype is presented in FIG. 19. It can be seen that the cross-polarization level is well below the co-polarization component for extremes of the antennas operating range. Similar performance is achieved throughout the band. This demonstrates that the proposed reconfiguration method has negligible impact on the radiation properties of the antenna in terms of generating any undesired cross-polarization.

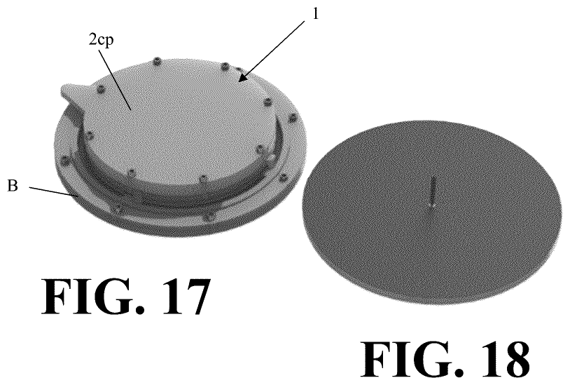

It should be appreciated that FIGS. 14-16 illustrate simulated and measured antenna gain performance including a static monopole comparison. In FIG. 14 the reconfigurable device 1 measured realized gain results that clearly demonstrated higher gain than a traditional quarter-wavelength monopole antenna (image of both for comparison depicted in FIGS. 17 and 18 to show that these devices had similar total sizes) across the operational frequency band of both antennas.

The simulated monopole antenna performance shown in FIGS. 14 and 15 was optimized for best results at a single height. A quarter-wavelength monopole operation is determined by its height so it does not allow any reconfigurability. It was chosen as the baseline for the comparison due to the similarity in radiation pattern shapes and total package volume.

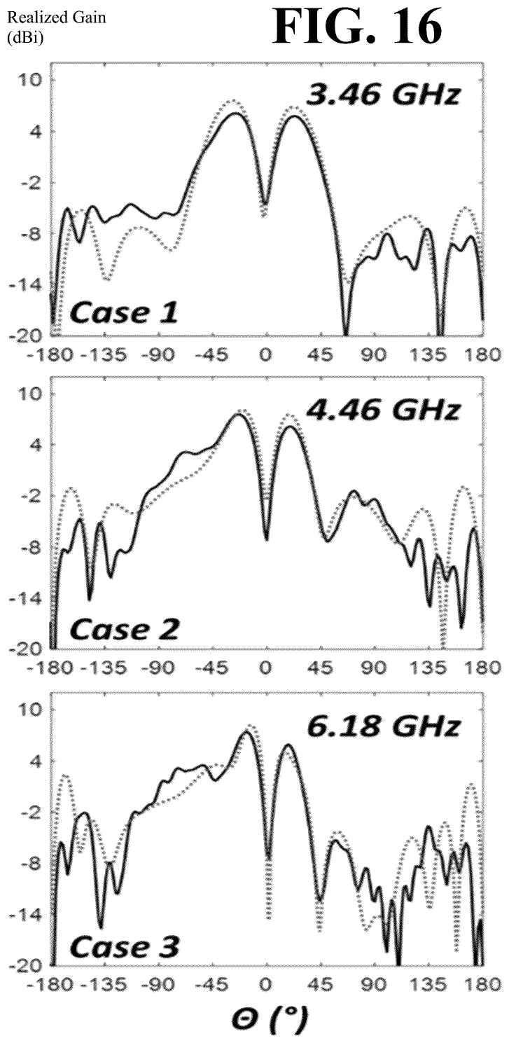

Three independent cases were isolated and FIG. 15 illustrates the prototype device 1 and monopole simulated radiation patterns (embodiment of our device is labeled “CMA” and the conventional monopole is labeled “Monopole”). The shading and size for the radiation patterns shown in FIG. 15 are scaled per realized gain values and are presented at the three case frequencies of 3.4 GHz, 4.46 GHz, and 6.18 GHz. It can be seen that the reconfigurable embodiment of our device 1 outperforms the static monopole in realized gain, as well as pattern shape retention. In FIG. 16, the (φ=0) was simulated and measured (co-polarization) results for the reconfigurable device were compared and demonstrate good agreement with simulation, indicating the simulated 3D radiation patterns shown in FIG. 15 are accurate and can be expected in application. These measured results serve to demonstrate examples of the types of enhanced performance capabilities embodiments of our device 1 can provide.

These results demonstrate that the excellent antenna feed match across the various frequencies, achieved by incorporating compliant mechanisms, allows significantly increased performance across a wide range of frequencies. The variations seen in the radiation patterns (FIG. 16), where certain configurations have slightly higher or lower realized gain in comparison to the simulation, is believed to be attributed once again to manufacturing errors and the clamp force altering the expected resultant impedance of the custom shorting pins.

An operational behavior for the device 1 can be attributed to the radially symmetric shorting pins SP perturbing the field distribution beneath the radiating patch 2cp due to their shunt inductive effect, which can increase the gain. It is also known that the fields in the region under the top loaded area can be expressed as a summation of the modal functions weighted by associated expansion coefficients and verified through full-wave Method of Moments (MoM) and wire-model methods. It can be considered that the antenna in this prototype was able to operate closer to an end-loaded monopole or higher-order microstrip patch than a traditional monopole with similar physical heights.

Conventional end-loaded monopole antennas and higher-order microstrip patch antennas have been extensively studied and have shown similar performance to simulations with high radiation efficiency and realized gains on the order of 7.5 dB. Moreover, for top-loaded monopole antennas, a maximum radiation angle of around 25-30 degrees has been achieved. These types of properties are all consistent with the properties of a prototype of our device 1.

The conducted evaluation of a prototype of an embodiment of our device 1 as discussed above show that embodiments of our device 1 can provide substantial improvements and advantages over conventional devices. For example, many origami-based antennas do not support continuous reconfiguration and are almost exclusively discrete systems. Moreover, origami-based systems also have limited frequency performance ranges due to their inherently discrete nature. In contrast, embodiments of our device 1 can utilize a compliant mechanism—that can enable continuously variable frequency selection and also exceptional total antenna efficiency as well as relatively high realized gain across the band (for embodiments configured as an antenna and not a different type of electromagnetic device).

It is also believed that due to the extreme versatility of the compliant mechanism 3 that can be provided in a device 1, polarization reconfiguration can be easily incorporated into a new antenna design or even the currently presented devices. This provides yet additional benefits for different embodiments of our device.

Compliant mechanisms can be included in a body 2 of a device to help eliminate the need for key joints that require lubrication. Instead, movement of the body can be provided via a compliant mechanism 3 (e.g. a portion of a body 2 that is shaped and/or defined so it can defined motion for deformation by a single continuous material that can also in-turn reduce part count, as well as redundancy in actuation). This type of mechanism can also help permit bodies to have reduced size and, in some cases, permit miniaturization of a body for a device. As can be appreciated from the above example, excellent performance at minimal complexity can be provided by some embodiments of our device that utilize a compliant mechanism 3 so improved performance and operational flexibility can be provided while also reducing the cost of manufacture and time needed for manufacturing of an embodiment.

It should also be noted that the above evaluated prototype was fabricated with currently available 3D printable materials. More specialized or advanced additive manufacturing and use of other material selection options can provide numerous other application options for designs of other embodiments of our device 1.

Mechanical devices can be subject to rigorous testing to determine their expected lifetime. These same lifetime tests can be applied to electrical devices such as capacitors, electrical connectors and batteries that have charge/discharge cycles, insertion limits and environmental operating conditions.

For example, materials can suffer from fatigue and plastic deformation if their limits are exceeded. Through proper design and simulation, extensive mechanical operational cycles can be achieved with compliant mechanisms that may be specifically created for a particular set of operational criteria and/or design criteria.

For instance, capacitor life can be reduced with just a 10° C. increase in temperature (and changes corresponding to internal losses). Mechanical fatigue testing of electrical switches, copper traces, printed circuit board (PCB) laminates as well as solder joints are typically not evaluated for mechanical robustness, but if a solder joint were to succumb to fatigue failure a electrical switch can be essentially rendered in-operable. It has even been noted that PCB laminates (a key material that is typically chosen for electrical transmission properties and not mechanical robustness) are most likely a significant factor that influences the overall reliability of electronic assemblies.

When the aspect of high-power is then also considered, low-loss polymers convert the absorbed energy into heat and if the loss is low enough the heat generated can be radiated easily to the environment. Varactor-based devices, as mentioned previously, suffer from high field enhancement produced by the structure geometry, which in-turn limits their performance and restricts the application space.

As for the specific material used in the design of the prototype discussed above that was subjected to testing and evaluation, the material had a dielectric breakdown strength of around 30 MV/m. When investigating the maximum electric fields within the cavity and external to the cavity, the maximum electric fields were seen to be around the coaxial input pin. The total power handling capability is calculated to be over 28 kW. When the SMA connector for the device was taken into account, the input connector was found to be the limiting component of the specific design (limited to approximately 500 Watts, dependent on frequency and manufacturer).

The above discussed results demonstrate that embodiments of our device 1 can be designed as reconfigurable antenna devices to provide antennas that can have continuously tunable frequency operation across a wide frequency range of nearly an octave. The realized gain across the operational band ranged from 6.1 to 10.8 dBi for one embodiment, for example.

Additionally, the incorporation of a 3D printed structure allowed a substantial part reduction over other methods of pin reconfiguration while still maintaining a light weight and low height profile for the fabricated prototype that was evaluated. The removal of varactors and pin-diodes that can be provided can permit embodiments to be designed for practical implementation into high-power and radiation hardened environments.

For example, embodiments of our device 1 can be provided that may utilize a different type of ground plane (e.g. a hexagonal shaped ground plane), which can provide higher packing efficiencies for antenna array implementations.

Embodiments can be designed so fabrication can utilize 3D printing for components of the device or for the device fabrication, which can allow multiple material selections and the realization of novel geometries for different embodiments.

Furthermore, by engineering compliant mechanical systems with specific dual (mechanical and electrical) properties, the electrical components of the device can be either reduced or eliminated. Also, the number of conventional mechanical components for such devices be reduced/eliminated by implementation of an embodiment of our device. Part reduction and/or elimination can provide significant improvements in reliable operation and manufacturability.

### Second Example—Evaluation of Other Embodiments

To further demonstrate the capabilities of embodiments of our device, a prototype of another embodiment of our device was designed. This additional prototype utilized a different rotational translation approach for a different application. This second prototype design was based on a shorted resonator unit-cell and was fabricated to incorporate a compliant mechanism 3 to provide a reconfigurable phase-gradient metasurface for reflect-array applications.

Similar to the coaxial fed patch antenna with shorting pins prototype of the embodiment discussed above, the unit-cell model relied on a leaf spring element to provide continuous reconfiguration. The proposed compliant mechanism 3 of this prototype was also able to provide a continuous range of selection states (or operational orientations for the body 2) to be achieved while also enabling a decrease in fabrication complexity as actuation for adjustment in device orientation could be provided by an inexpensive stepper motor and associated simple driver hardware/software to drive adjustment of the body 2 into different orientations via application of a linear force for compressing the body 2 to deform the body 2 into different shapes, or orientations.

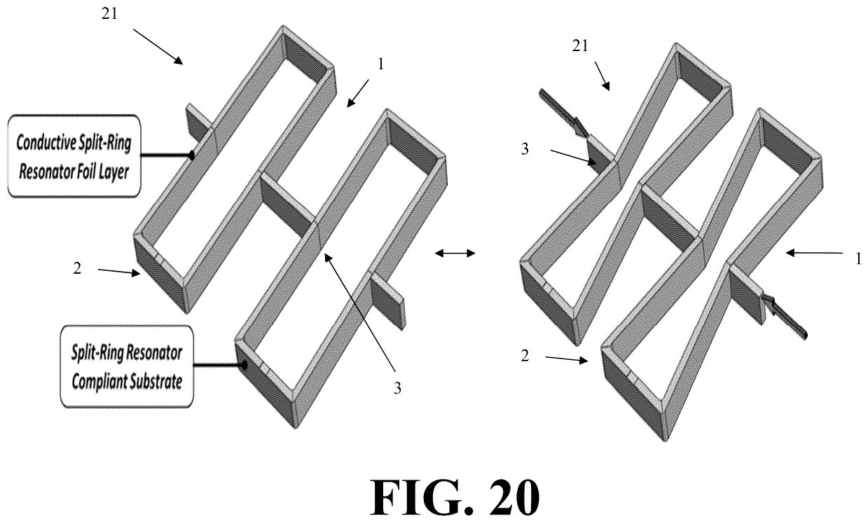

The concept and operation of the proposed reconfigurable unit-cell of this additional embodiment is shown in FIG. 20. As indicated in FIG. 20, one or more actuators (e.g. gas spring, hydraulic spring, linearly moveable actuator, etc.) can be provided to exert a linear force to drive a change in orientation of the body 2 of the device 1.

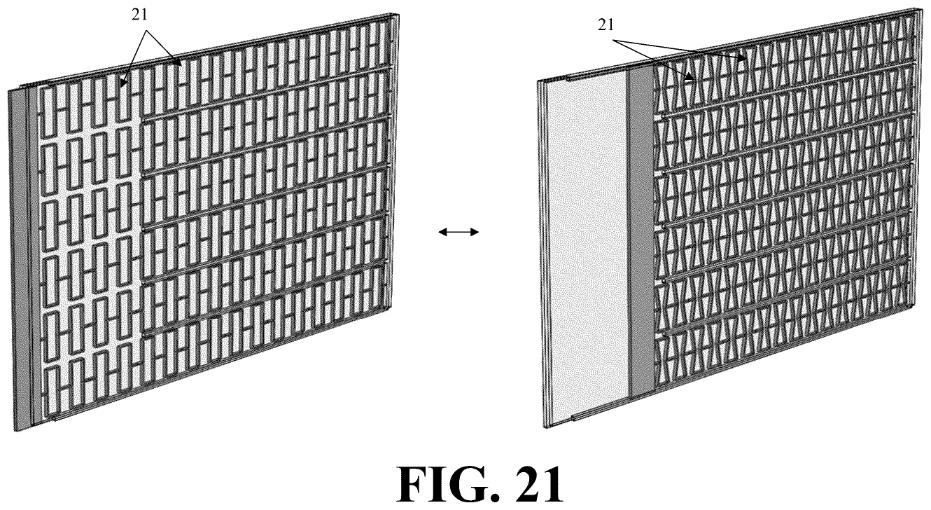

The body 2 of the device 1 can be structured to include a conductive split ring resonator foil layer and also have a split ring resonator compliant substrate. The body 2 can be deformable via actuation of a force in at least one direction to compress the body 2 into different shapes as indicated in FIG. 20. The compression of the body 2 can adjust how the body may function to resonate a signal or an electromagnetic field. Each body 2 can define a single cell 21. The cell can be utilized as a single cell device or in a multi-cell device (e.g. the embodiment shown in FIG. 21).

To further demonstrate the capabilities of embodiments of our device, a prototype of another embodiment of our device was designed. This additional prototype utilized a third design to provide a reconfigurable compliant mechanism frequency selective surface (CM-FSS) derived from a body 2 of a device 1 having a linearly actuated compliant mechanism. As may best be appreciated from FIG. 21, the prototype of this embodiment utilized a number of bodies 2 designed similarly to the body 2 of the second embodiment shown in FIG. 20 to form a larger array.

Based on conducted testing, it was found that when the unit-cell of the device 1 was moved into a flexed state orientation, or compressed state orientation, the bodies 2 can be oriented to reflect all the incident energy back to the source to provide a band stop configuration. In contrast, when the bodies 2 of each unit-cell are in a fully relaxed state (e.g. not compressed), nearly all of the incident energy was allowed to pass through undisturbed to provide a band pass configuration.

The prototypes of the embodiments shown in FIGS. 20 and 21 were formed utilizing an additively manufactured material as the substrate. However, for field-deployment, other substrate materials for formation of the body 2 and compliant mechanism 3 of the body can be utilized. For example, a substrate material such as Polytetrafluoroethylene (PTFE), which is not significantly affected by UV exposure and not significantly affected by embrittlement over time can be selected for use to allow a ruggedized CM-FSS structure to survive harsh environments.

A prototype of the embodiment shown in FIG. 20 was evaluated for transmission S₂₁ and reflection S₁₁ magnitudes for normally incident waves upon the CM-FSS. The prototype in the compressed state was able to exhibit single-band filtering performance (i.e., a band stop) at around 3 GHz. The relaxed CM-FSS state demonstrated excellent band-pass performance at 3 GHz.

FIG. 21 illustrates an exemplary embodiment that includes a full CM-FSS panel with the individual unit-cells 21 captured between two guide sheets as well as guide channels. The compression force for adjustment of the device orientation can be applied by a polymer guide plate that can be actuated through linear stepper motors for precise control, or as a discrete system with an on-off configuration. The panel of different cells 21 in the embodiment of FIG. 21 can be configured to provide different types of band gap and band stop functionality via orientation of the cells that can be provided via one or more actuators 4 adjusting the orientation of the bodies 2 of the cells 21.

### Third Example—Evaluation of Yet Other Embodiments

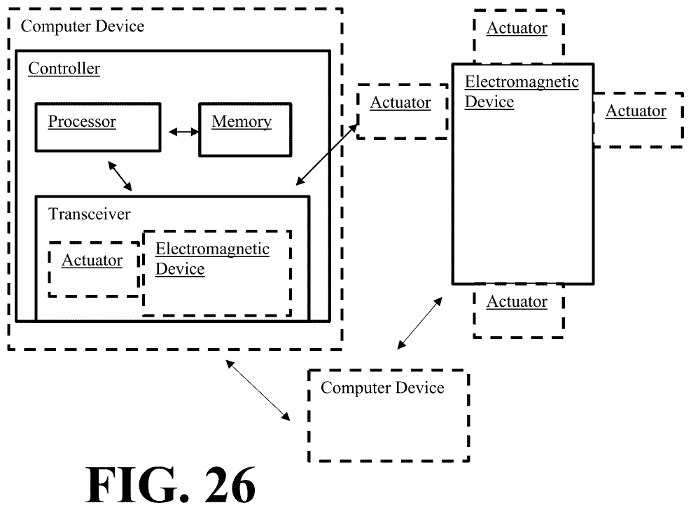

Other embodiments were also evaluated to evaluate embodiments of the device 1 that can be configured to utilize a waveguide fed dielectric rod antenna with steering reconfigurability that can be provided via a multi-axis variable compliant mechanism 3. Examples of these embodiments are shown in FIGS. 22-24 and evaluation results from testing of a prototype of such an embodiment is shown in FIG. 26.

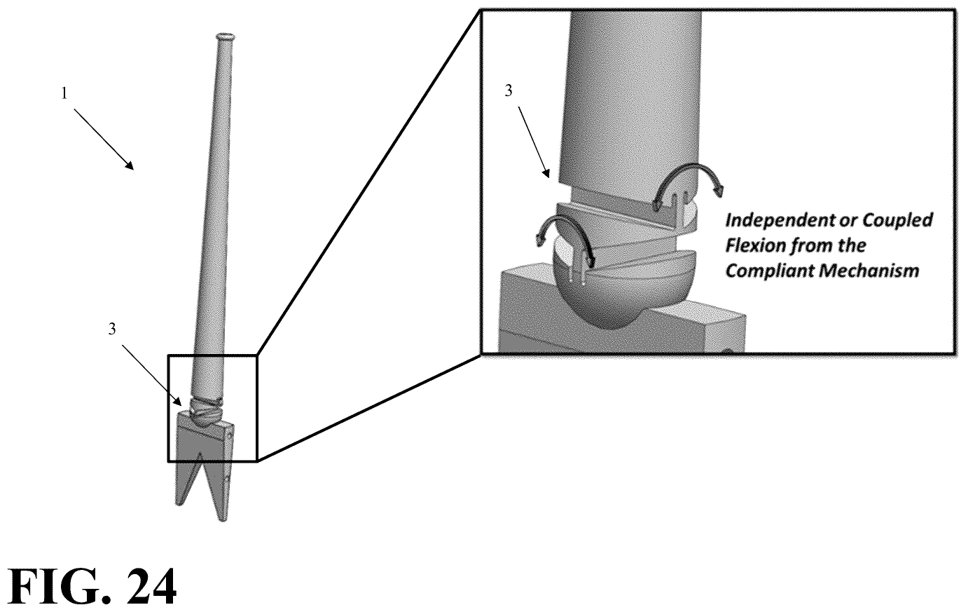

As may best be seen from FIGS. 23 and 24, a compliant mechanism 3 of a body can be defined to include multiple different transverse living hinge elements for flexion along different axes of rotation, or flexion. For instance, a first axis of flexion can be defined above and also be transverse to a second lower axis of flexion. The defined axes can be perpendicular to each other or otherwise transverse to each other. The different axes of flexion can permit an upper elongated rod element to be moved in multiple directions via flexing that can occur at the axes of flexion defined by the compliant mechanism 3 of the body 2.

In addition to increased gain and beam-steering capabilities, this design concept of these embodiments of FIGS. 22-24 can be further extended to achieve dynamic polarization control. Conventional dielectric rod antennas can require array configurations and complex feeding array networks to achieve steering. With the implementation of compliant mechanisms 3 as shown in the exemplary embodiments of FIGS. 22-24, a deployable rugged system that can provide a simple method of achieving steering (e.g. use of one or more actuators 4, etc.) without the use of multiple antenna elements and feeding networks.

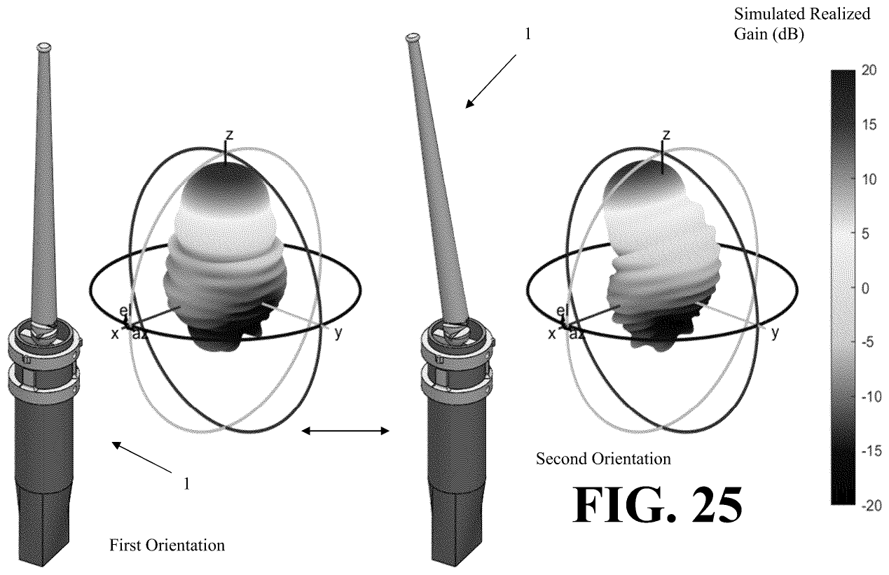

As may be seen from FIG. 25, for example, a prototype of the exemplary embodiment shown in FIGS. 22-23 can be moved between a first orientation that can provide a broadside configuration and multiple steered configurations, such as an exemplary steered configuration illustrated as a second orientation in FIG. 25. Simulations were performed to evaluate beam fidelity and gain performance for this embodiment and the results of this simulation work is shown in the graphs of FIG. 25 positioned adjacent to the device 1 in each illustrated orientation. As is clear from FIG. 25, the prototype was able to provide excellent realized gain performance and beam fidelity in both orientations.

The results of our evaluations of different prototypes of exemplary embodiments of our device show that embodiments of our device can be utilized in reconfigurable communication and electrical systems to augment conventional technology and enable performance that would otherwise be impractical for current state-of-the-art technology (e.g. harsh environment conditions, outer space, etc.).

It should be appreciated that embodiments of our electromagnetic device can be structured and configured for use in different applications. For example, embodiments can be utilized in phase shifters, filers, metamaterial enabled reflectarray antennas, antennas, and reconfigurable intelligent surfaces. Embodiments can permit utilization of reconfigurable metamaterials and radiation pattern adjustment. Some embodiments can be implemented into on-chip applications while others can be configured to high-power applications. Rugged designs that can be provided by embodiments can also permit embodiments to be configured for applications in harsh environments (e.g. space exploration applications, satellites) or harsh industrial environments (mining or construction environments, harsh chemical processing environments, etc.).

Embodiments of our device can provide significant structural improvement in performance, device life, and reliability by permitting elimination of joints, gears and linkages through the implementation of a complaint mechanism 3 (e.g. a mechanism that can often use a single continuous material that also in-turn reduces part count, reduces assembly time and removes backlash in reconfiguration). Embodiments can also provide expanded performance operational space by incorporating reliable mechanical reconfiguration abilities as noted above, for example.

While certain present preferred exemplary embodiments of our electromagnetic device, compliant adjustment mechanisms for such device, communication systems, processes for electromagnetic device adjustment, and exemplary embodiments of methods for making and using the same have been shown and described above, it is to be distinctly understood that the invention is not limited thereto but may be otherwise variously embodied and practiced within the scope of the following claims.

We claim:

1. An electromagnetic device comprising:
a body having a compliant mechanism, the body being continuously adjustable between different orientations via the compliant mechanism for adjusting at least one electromagnetic property of the electromagnetic device.

2. The device of claim 1, wherein the compliant mechanism includes:
a plurality of arms attached to short pins, the arms being resiliently moveable via rotation of a portion of the body, the short pins being in contact with a ground plane below the arms and also being in contact with an upper radiating patch above the arms during motion of the arms, the arms being movable via rotation of the portion of the body to adjust positions of the short pins around a feed pin.

3. The device of claim 1, wherein the body defines a unit cell that is compressible from a relaxed state to multiple different compressed states via the compliant mechanism.

4. The device of claim 1, wherein the body is compressible via application of at least one linearly applied force.

5. The device of claim 1, comprising:
at least one actuator positioned to engage the body to adjust the orientation of the body.

6. The device of claim 5, comprising a controller communicatively connected to the at least one actuator.

7. The device of claim 1, wherein the compliant mechanism includes a first pre-defined axis of flexion and a second pre-defined axis of flexion that is transverse or perpendicular to the first pre-defined axis of flexion.

8. The device of claim 1, wherein the device is configured as an antenna.

9. The device of claim 1, wherein the device is adjustable between at least one orientation at which the device is a band stop filter and at least one orientation in which the device is a band pass filter.

10. A process for adjusting at least one electromagnetic parameter of a device, the process comprising:
adjusting an orientation of a body of an electromagnetic device by engaging the body via at least one linearly applied force and/or at least one rotationally applied force.

11. The process of claim 10, comprising:
determining that the at least one electromagnetic parameter fails to meet a pre-selected criteria; and
wherein the adjusting of the orientation of the body is performed in response to the determining that the at least one electromagnetic parameter fails to meet a pre-selected criteria.

12. The process of claim 10, wherein the compliant mechanism is defined in the body to facilitate continuous adjustment in the orientation of the body between a first orientation and a second orientation.

13. The process of claim 10, wherein adjusting of the orientation includes one or more of moving arms of the body, rotating arms of the body, flexing the body about a first pre-defined axis of flexion and flexing the body about a second pre-defined axis of flexion.

14. The process of claim 13, wherein the first pre-defined axis of flexion is perpendicular to the second pre-defined axis of flexion.

15. The process of claim 10, wherein the electromagnetic device is an antenna.

16. The process of claim 10, wherein the adjusting of the orientation changes the at least one electromagnetic parameter such that the device is adjustable from a band stop configuration to a band pass configuration.

17. The process of claim 10, wherein the adjusting of the orientation changes the at least one electromagnetic parameter such that the device is receptive within a band that is over 2 GHz.

18. The process of claim 17, wherein the band is between 3.46 GHz and 6.37 GHz or the band is between 3.5 GHz and 6.2 GHz.

19. An apparatus comprising:
an electromagnetic device including a body having a compliant mechanism, the body being continuously adjustable between different orientations via the compliant mechanism for adjusting at least one electromagnetic property of the electromagnetic device;
at least one actuator positioned to engage the body to adjust the orientation of the body;
a computer device communicatively connected to the at least one actuator to control the at least one actuator for adjustment of the orientation of the body, the computer device including a processor connected to a non-transitory computer readable medium.

20. The apparatus of claim 19, wherein the computer device is a controller.
